(19) United States
(12) Patent Application Publication
(10) Pub. No.: US 2006/0072953 A1
(43) Pub. Date: Apr. 6, 2006

(54) Ticket presenter for use with a ticket printer having a tear bar therein

(76) Inventors: Daniel Vienneau, Dieppe (CA); Rick Saulnier, Dieppe (CA); Pierre Doucet, Dieppe (CA); Michel Vienneau, Dieppe (CA); Paul Chiasson, Dieppe (CA); Aurele Comeau, Dieppe (CA); Martin Gaudet, Dieppe (CA); Aurele Comeau, Dieppe (CA)

Correspondence Address: MARIO D. THERIAULT, 812 HWY. 101 NASONWORTH, FREDERICTON, NB, E3C 2B5, CA

(21) Appl. No.: 10/956,257

(22) Filed: Oct. 4, 2004

(51) Int. Cl. B41J 11/70

(52) U.S. Cl. 400/621

(57) ABSTRACT

The ticket presenter is mountable to a printer having a tear bar therein, for receiving a printed ticket, for pulling on that ticket in a controlled manner, for severing the ticket against the tear bar of the printer and for presenting the ticket to a customer. A paper inlet switch mounted inside the ticket presenter has a lever extending in the inlet path of the ticket presenter for monitoring the extent of a loop formed in the strip of ticket paper in the inlet path. A tension roller system is mounted on a downstream side of the paper inlet switch, and pulls on the strip of ticket paper with a speed that is controlled by the position of the lever of the paper inlet switch in the inlet path. The speed and functions of the ticket presenter are thereby synchronized to the speed and functions of the ticket printer.

### FIELD OF THE INVENTION

This invention pertains to ticket presenters, and more particularly it relates to a ticket presenter for installation on a ticket printer having a tear bar therein for severing printed tickets from a strip of ticket paper.

### BACKGROUND OF THE INVENTION

Ticket printers having tear bars therein are preferred by most users for their simplicity and reliability. In this type of printer, the end of the printed ticket extends through an outlet slot and is simply pulled out by the customer, causing it to separate from a strip of ticket paper inside the printer. In most of the prior art devices, the paper strip is fed through the printer by rollers and is held by the nip of the rollers after a ticket has been printed, to allow a customer to pull on it and to cut it.

The cutting blade of the printer, or tear bar, as it is commonly referred to in this field, is mounted in the outlet chute on the downstream side of the feed rollers. Generally, the outlet chute has a curve therein and the tear bar is mounted in that curve and lies against the paper strip. The outlet chute is aligned relative to the tear bar such that the pulling force applied to the ticket by a customer makes a large angle with the edge of the tear bar. Because of this alignment of the outlet chute, the ticket is easily and reliably severed from the paper strip when a moderate force is applied to it. These types of severing devices have no moving parts, no electronic components and are virtually maintenance free.

Examples of ticket printers having tear bars therein for severing tickets from a strip of ticket paper are described in the following documents:
U.S. Pat. No. 5,407,115 issued to D. F. Blalock et al. on Apr. 18, 1995;
U.S. Pat. No. 5,980,138 issued to T. Shiozaki et al. on Nov. 9, 1999;
U.S. Pat. No. 6,151,055 issued to H. S. Ackley et al. on Nov. 21, 2000;
U.S. Pat. No. 6,325,558 issued to C. W. Robinson on Dec. 4, 2001;
U.S. Pat. No. 6,524,022 issued to M. Minowa et al. on Feb. 25, 2003;
U.S. Pat. No. 6,575,090 issued to D. Vienneau et al. on Jun. 10, 2003;
U.S. application 2003/0223,800 published by C. A. Wiklofet al. on Dec. 4, 2003;

Although ticket printers with a stationary tear bar are preferred by many users, there are applications where ticket printers having mechanical severing devices therein, incorporated with ticket presenters, are more suitable. These applications include printers for heavy gauge ticket paper, tickets that need to be tilted face up before presenting to a customer, tickets that should have clean cut edges, or other applications where a tension on the printed ticket could damage the printing head or other components inside the printer.

Numerous types of mechanical severing mechanisms have been developed in the past. One of the most common severing mechanisms in this field is a guillotine type having a blade moving across the path of the ticket paper, either from the side or at right angle with the surface of the paper strip. In another common type of severing mechanisms, the paper strip lies between the flat surface of a roll on which a longitudinal segment has been taken off and an anvil bar. The rotation of the roll causes the paper strip to be sheared against the anvil bar.

Ticket printers having mechanical severing mechanisms also generally have discharge rollers and paper guides which cooperate together to present the severed ticket to a customer in such a way that it is easily grasped by the customer. Some printers with mechanical severing mechanisms have magazines therein for stacking a number of tickets that are printed in sequence for a same customer. These discharge chutes and associated rollers, guides and magazines are referred to in the industry as ticket presenters.

Examples of ticket printers having mechanical severing mechanisms and ticket presenters are illustrated and described in the following documents:
U.S. Pat. No. 4,192,618 issued to N. Kondur, Jr. et al. on Mar. 11, 1980;
U.S. Pat. No. 4,297,039 issued to R. Lees on Oct. 27, 1981;
U.S. Pat. No. 5,215,393 issued to T. Wincent on Jun. 1, 1993;
U.S. Pat. No. 5,478,161 issued to K. Suzuki et al. on Dec. 26, 1995;
U.S. Pat. No. 5,782,567 issued to K. Endo on Jul. 21, 1998;
U.S. Pat. No. 5,921,686 issued to D. J. Baird et al. on Jul. 13, 1999;
U.S. Pat. No. 5,954,438 issued to G. F. Klein et al. on Sep. 21, 1999;
U.S. Pat. No. 6,162,159 issued to C. D. Martini et al. on Dec. 19, 2000;
EP 0,305,153 published by J. R. Maud on Mar. 1, 1989.

In high usage ticket printing applications, with relatively thin paper and luxurious printer cabinets, as in printers of lottery tickets for example, it is often desirable to combine the endurance of a stationary tear bar with the elegance of a ticket presenter. Although the ticket printers of the prior art deserve undeniable merits, there is no known prior art that combines the advantage of a stationary tear bar with the convenience of a ticket presenter. Therefore, it is believed that a need exists for a ticket presenter that can be mounted as an optional accessory to a ticket printer having a tear bar therein.

### SUMMARY OF THE INVENTION

In the present invention, however, there is provided a ticket presenter that is mountable to a ticket printer having a stationary tear bar. The ticket presenter according to the present invention monitors the tension in the strip of ticket paper and determines whether the printer is preparing for printing, is currently printing or has completed printing, and operates accordingly. Although the ticket presenter according to the present invention is physically mounted to the frame of a ticket printer, it operates as a stand alone unit without communication circuit connected to the ticket printer.

According to one feature of the present invention, there is provided a ticket presenter for receiving a printed ticket from a printer, for pulling on that ticket in a controlled manner and for presenting the ticket to a customer with its printed side facing upward. Broadly, the ticket presenter according to the present invention comprises a paper inlet path, a paper inlet switch having a lever extending in the paper inlet path, a pair of rollers in a downstream side of the paper inlet switch, and an electronic feedback loop and associated circuitry communicating with the paper inlet switch and the drive of the rollers. The feedback loop and associated circuitry monitor the position of the lever in the paper inlet path, by measuring the voltage on the paper inlet switch, and adjust the speed of the rollers according to that position.

When the ticket presenter is installed on the outlet side of a ticket printer, and the paper paths of both devices are aligned, a strip of ticket paper extending into the ticket presenter is held between the nip of the rollers in the ticket presenter, and the lever of the switch is urged against the paper strip. The extent of a loop formed by the paper strip in the inlet path of the ticket presenter is monitored by the paper inlet switch, and the speed of the rollers is adjusted accordingly. During printing of a ticket, the speed of the rollers is adjusted to maintain the lever of the switch within a certain region, to prevent pulling too hard or not hard enough on the strip of ticket paper. When printing stops, the rollers pull on the paper strip with an appropriate speed and torque to cut the printed ticket from the strip of paper, against the tear bar of the printer.

The ticket presenter according to the present invention uses the speed of the strip of ticket paper coming out of the ticket printer as a communication means to synchronize the speed of the rollers thereof according to the speed of the ticket printer. The ticket presenter is thereby mountable to various types of ticket printers without any modification or addition of electronic hardware to the ticket printer.

In accordance with another aspect of the ticket presenter according to the present invention, the inlet path extends from the inlet opening thereof to the nip of the rollers, and an outlet path extends from the nip of the rollers to an outlet opening thereof. A deflector is mounted above the nip of the rollers and separates the inlet path and the outlet path. In the present invention, the rotation of the rollers is reversible, and a ticket storage slot extends below the nip of the rollers.

A ticket that has been printed on its lower side is temporarily stored in the storage slot. After being severed from the strip of ticket paper, the trailing edge of the ticket is moved below the deflector and up again against the deflector on the outlet side of the deflector. The ticket is then moved into the outlet path and presented to a customer with its printed side on top.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

One embodiment of the present invention is illustrated in the accompanying drawings, in which like numerals denote like parts throughout the several views, and in which:

FIG. 1 is a perspective top, right side and rear view of a ticket printer, on which is mounted a ticket presenter according to the preferred embodiment of the present invention;

FIG. 2 is a perspective top, right side and front view of the ticket printer shown in FIG. 1 with the cover open to show the tear bar and the paper outlet switch therein;

FIG. 3 is a cross-section view of the ticket printer and presenter as seen along line 3-3 of FIG. 1;

FIG. 4 is a diagram showing the functions of the ticket printer and the functions of the ticket presenter;

FIG. 5 is a diagram of the tension modes applied to the strip of ticket paper by the rollers of the ticket presenter;

FIG. 6 is an enlarged cross-section view of the printer outlet switch mounted inside the ticket printer;

FIG. 7 is an enlarged cross-section view of the paper inlet switch mounted inside the ticket presenter;

FIG. 8 is an enlarged cross-section view of the outlet switch mounted inside the ticket presenter;

FIG. 9 is a graph showing the voltage on the paper inlet switch corresponding to various positions of the lever of that switch.

### DESCRIPTION OF THE PREFERRED EMBODIMENT

While this invention is susceptible of embodiment in many different forms, there is shown in the drawings and will be described in details herein one specific embodiment, with the understanding that the present disclosure is to be considered as an example of the principles of the invention and is not intended to limit the invention to the embodiment illustrated and described.

The ticket presenter according to the preferred embodiment is described herein in a combination with a ticket printer to facilitate the drafting of the present disclosure. The ticket printer described herein is of the common type that can print tickets of various lengths and widths on a variety of thermally sensitive media. It should be appreciated, however, that this printer is not the only type of printers with which the ticket presenter can be used.

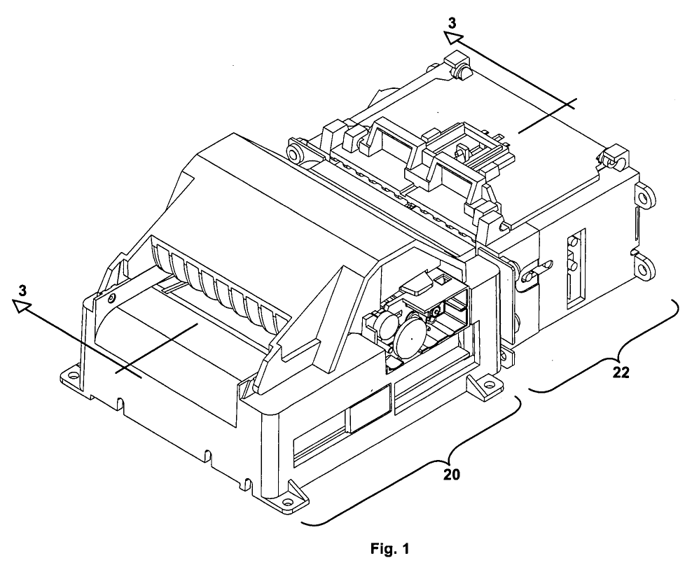

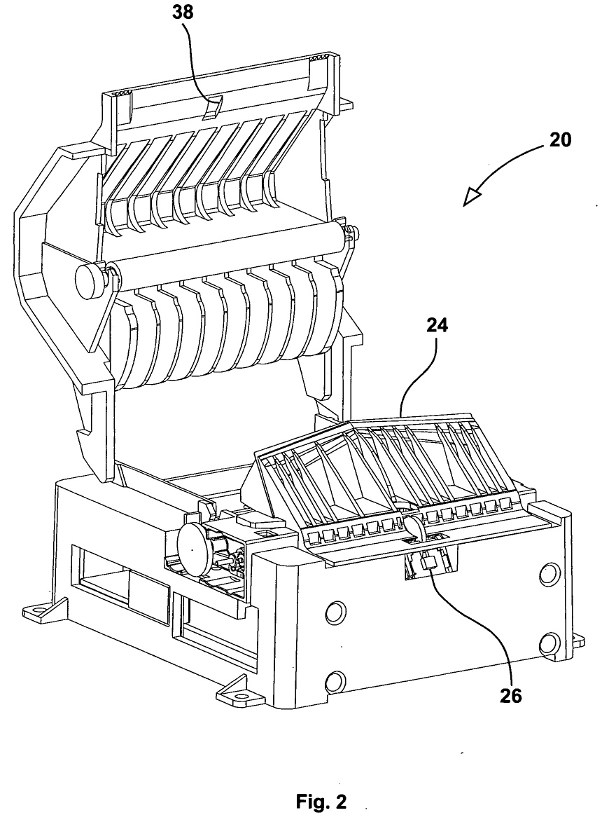

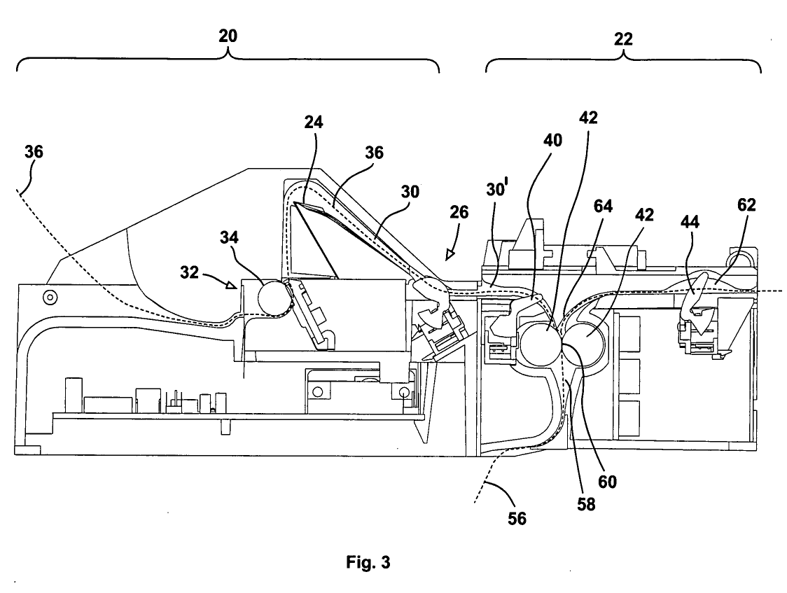

The ticket presenter according to the preferred embodiment of the present invention is illustrated in FIGS. 1 and 3, in a combination with the ticket printer. The ticket printer is labelled as 20 and the ticket presenter is labelled as 22. The ticket printer 20 is illustrated in isolation in FIG. 2 to show the tear bar 24 therein.

A first limit switch 26 is mounted on the downstream side of the tear bar 24. This switch 26 is referred to as the printer outlet switch. This printer outlet switch has a lever 28 extending across the paper path 30, as better seen in FIG. 6. The lever 28 of the switch 26 is urged toward the paper path 30 by a torsion spring (not shown) mounted on its pivot. The switch 26 can detect three conditions. The first condition corresponds to the position of the lever 28 when the lever is fully extended across the paper path 30. This condition corresponds to a full voltage on the switch indicating “no paper” in the paper path 30. The second condition corresponds to the position of the lever 28 when the lever 28 is in an intermediate position, giving an intermediate voltage across the switch. This intermediate voltage indicates a “paper present” condition in the paper path. The third condition is detected when the lever 28 is pushed in fully. This third position corresponds to a low or no voltage across the switch. This third position indicates a “paper jam” condition, where wrinkled paper pushes the lever 28 to its extreme position.

Depending upon which state the printer outlet switch 26 is in, the ticket printer responds accordingly. For example, if the ticket printer is turned on and the switch 26 is in the “no paper” condition, then the ticket printer will feed paper until a “paper present” condition is met. Alternatively, if an obstruction is placed in front of the paper outlet opening, a loop is formed in the paper strip, thereby moving the switch lever to the “paper jam” position, and the ticket printer stops printing until the obstruction is removed.

The printer outlet switch 26 is an integral part of the ticket printer circuitry (not shown) and its condition outputs are used exclusively to control the operation of the ticket printer 20.

The ticket printer 20 also has a printing head 32 therein and a drive roller 34 that drives a strip 36 of ticket paper along the paper path 30 and over the tear bar 24 thereof. The ticket printer 20 can be used in a standalone mode, wherein a customer could grasp the ticket and pull on it so that the tension in the ticket forces it against the tear bar 24 and the ticket is cut off from the strip 36 of ticket paper. The strip 36 of ticket paper is also referred to herein as the paper strip 36, for convenience.

A cavity 38 in the cover of the ticket printer 20 aligns with the lever 28 of the printer outlet switch 26 to allow the lever to extend beyond the thickness of the paper path 30 and to provide an accurate “paper present” signal.

The other elements of the ticket printer 20 are not illustrated herein because these elements are well known in the art and do not constitute the focus of the present invention. Preferably, the tear bar 24 has a smooth edge and a pointed shape. However, this shape is not essential, as other types of tear bars can also be used.

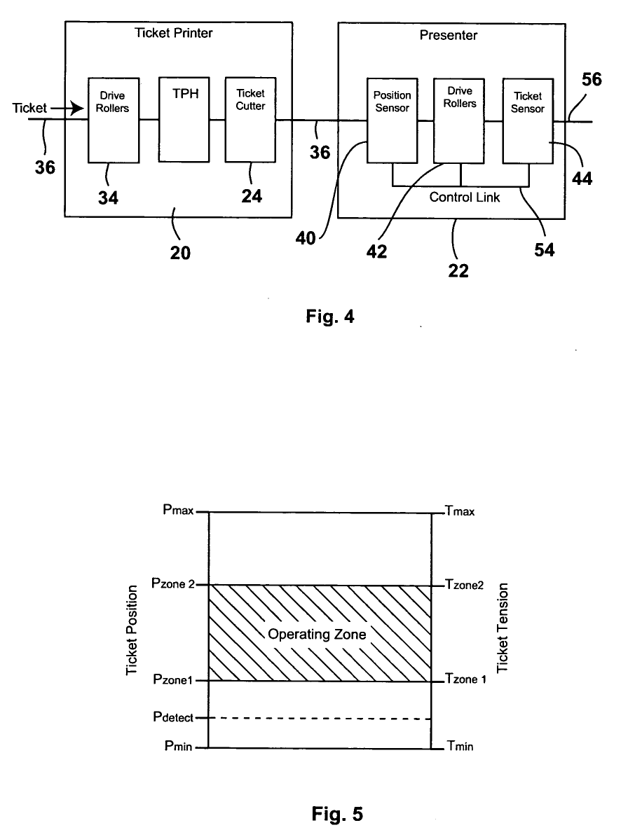

The ticket presenter 22 according to the preferred embodiment is mounted to the structure of the ticket printer 20 in any usual way, which is not described herein for also not being the focus of the present invention. The ticket presenter 22 accepts a ticket that is being printed by the ticket printer 20 and temporarily stores it until the printing is completed. Then the ticket presenter 22 pulls on the ticket, cuts the ticket over the tear bar 24, tilts it over and presents it to a customer. Although the operation of the ticket presenter 22 is in sequence with the printing of the ticket, the ticket presenter 22 has its own switches that makes it electronically-independent from the ticket printer 20, as illustrated in FIG. 4.

In FIG. 4, the ticket printer 20 is represented broadly, as a combination of a drive roller system 34, a ticket printing head TPH and a tear bar 24. The ticket presenter 22 is represented broadly as a combination of a paper position sensor, which function is effected by a paper inlet switch 40, a traction roller system 42 and a ticket sensor, which function is effected by an outlet switch 44.

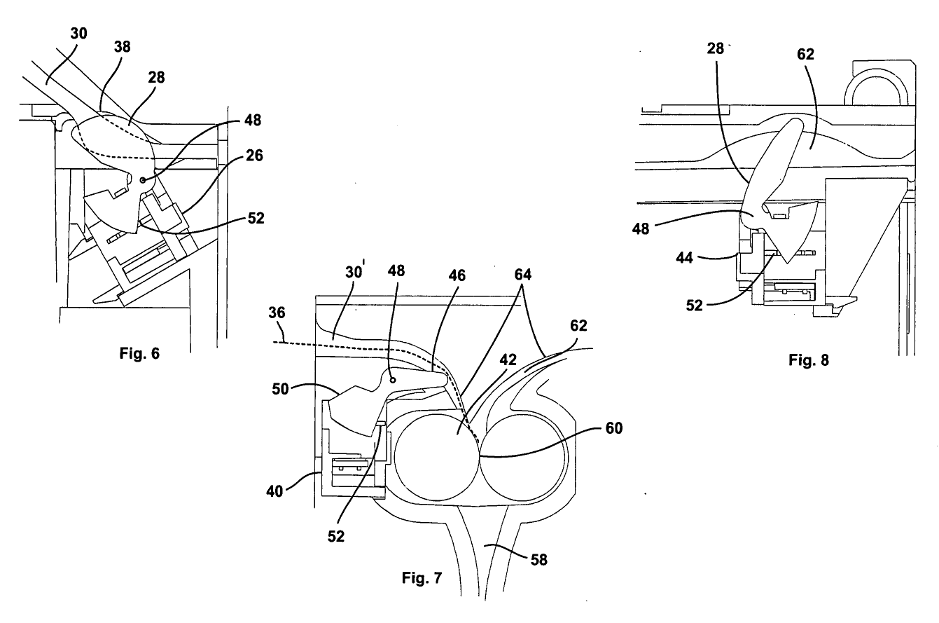

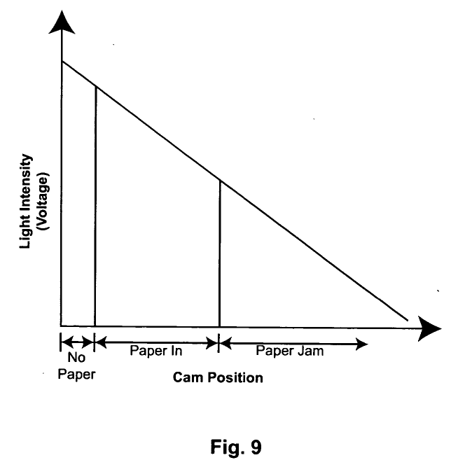

Referring back to FIG. 3, the paper inlet switch 40 is mounted on the upstream side of a pair of traction rollers 42, and the outlet switch 44 is mounted on the downstream side of the traction rollers 42. The paper inlet switch 40, in particular, is used to measure the tension in the strip 36 of ticket paper. The paper inlet switch 40 has a lever 46 mounted on a pivot 48 as illustrated in FIG. 7. The paper inlet switch 40 also has a torsion spring (not shown) that urges the lever 46 to extend into the paper inlet path 30′. As the paper strip 36 extends out of the ticket printer 20 and into the paper inlet path 30′ of the ticket presenter 22, the lever 46 of the paper inlet switch 40 is pressed downward, whereby the presence of the paper strip 36 can be detected. The tension rollers 42 are then put in motion to grab the end of the paper strip 36 and to pull on it in a controlled manner.

A cam 50 is integrally formed with the lever 46 and acts as a flag to cover a rectangular window 52, which is partly seen in FIG. 7 between a light emitter and a light receiver (not shown). The voltage on that switch is proportional to the amount of light passing through the window 52, and corresponds to the position of the cam 50 across the window 52.

Because of the torsion spring (not shown) which forces the lever 46 of the paper inlet switch 40 upward with a certain force, the voltage across that paper inlet switch 40 is representative of the tension applied to the paper strip 36 by the tension rollers 42. This voltage is used to control the speed of the tension rollers 42 so that an ideal tension is applied to the paper strip 36 during printing.

More particularly, the total operating range of the paper inlet switch 40 is divided into four zones, as shown in FIG. 5. The operating logic associated with the positions of the paper inlet switch 40 is as follows.

a) When the paper inlet switch 40 reads a P min position and a corresponding voltage, this signal is interpreted as a minimum tension T min, to indicate a “no paper” condition. This first condition causes the ticket presenter 22 to remain in an idle mode.

b) When the paper inlet switch 40 reads a P detect voltage, this signal is interpreted as being caused by the forward edge of the paper strip 36 entering the ticket presenter 22. Once the paper inlet switch 40 detects the presence of a paper strip 36, the tension rollers 42 are started at a preset default speed. A feedback loop 54, connected to the drive motor (not shown) of the tension rollers 42 and its associated circuitry (not shown) adjust the speed of the tension rollers 42 such that the tension in the paper strip 36 is maintained between a paper loose condition T zone 1, and a paper tight condition T zone 2. These two paper tension conditions can be adjusted within the range of movement of the paper inlet switch 40, by selecting the voltages associated with the desired corresponding switch positions P zone 1 and P zone 2.

The calibration of the paper inlet switch 40 and of the speed of the tension rollers 42 is advantageous for allowing the installation of the ticket presenter 22 on different types of ticket printers without applying undue stress on the drive mechanism of the ticket printer and without tearing the paper strip prematurely. This calibration of the paper inlet switch 40 and tension rollers 42 is advantageous for matching the speed of the tension rollers 42 with the speed of the paper strip 36 in a particular printer. The calibration of the speed of the tension rollers 42 using specific voltages on the paper inlet switch 40 is not described herein because such method and circuitry are known to those skilled in the art of motor controls.

c) When the ticket printer 20 has completed the printing of a ticket and stops feeding the paper strip 36, the sharp rise in tension in the paper strip causes the lever 46 to move to its lowest position indicating a P max voltage on the paper inlet switch 40. This signal causes the tension rollers 42 to pull the paper strip 36 over the tear blade 24 with a preset speed T max and a torque of a sufficient magnitude to tear a ticket 56 from the paper strip 36.

A portion of the ticket 56 is then fed into a storage slot 58 below the tension rollers 42 until the trailing edge (not shown) of the ticket is immediately above the nip 60 of the tension rollers 42, at which point the rotations of the tension rollers 42 are reversed to feed the ticket into the outlet path 62 and to present it to a customer in the usual way.

A deflector 64 is mounted between the inlet path 30′ and the outlet path 62 to guide the paper strip 36 from the inlet path and into the nip 60 of the rollers 42 and then to guide the printed ticket 56 from the storage slot 58 through the rollers 42 and into the outlet path 62. During the feeding of the printed ticket 56 below the deflector 64, and up again in the outlet path 62, the ticket is tilted over so that it is presented to a customer with the printing facing upward.

The outlet switch 44 is mounted in the outlet path 62, and its purpose, structure and operation are similar to those of the printer outlet switch 26, and therefore, further explanation on this switch is deemed unnecessary.

Although the ticket printer described herein has a stationary tear bar 24, it will be appreciated that the ticket presenter 22 according to the preferred embodiment can also be used with a printer having a guillotine type cutter. In that case, the tension rollers 42 are programmed to stop momentarily when a sharp rise in tension is detected by the paper inlet switch 40 to avoid pulling on the paper strip 36 during the operation of the mechanical cutter device.

The preferred switches 40, 44 are preferably set to operate in a normally closed mode such that a full voltage is seen in a “no paper condition”, as illustrated in FIG. 10. This is particularly advantageous for calibrating the functions of the switches during an initialization mode.

As to other manner of usage and operation of the present invention, the same should be apparent from the above description and accompanying drawings, and accordingly further discussion relative to the manner of usage and operation of the invention would be considered repetitious and is not provided.

While one embodiment of the present invention has been illustrated and described herein above, it will be appreciated by those skilled in the art that various modifications, alternate constructions and equivalents may be employed without departing from the true spirit and scope of the invention. Therefore, the above description and the illustrations should not be construed as limiting the scope of the invention which is defined by the appended claims.

We claim:

1. A ticket presenter for receiving a printed ticket from a ticket printer, for pulling on said ticket in a controlled manner and for presenting said ticket to a customer; said ticket presenter comprising;
a paper inlet path therein having a downstream direction;
a paper inlet switch mounted therein and having a lever extending in said paper inlet path;
paper feed roller means mounted therein in a downstream side of said paper inlet switch, and
means to monitor a position of said lever in said paper inlet path and to adjust a speed of said paper feed roller means according to said position.

2. The ticket presenter as claimed in claim 1, wherein said paper feed roller means comprises a pair of rollers and a nip between said rollers.

3. The ticket presenter as claimed in claim 2, wherein said paper inlet path extends from an inlet opening thereof to said nip, and further comprising an outlet path extending from said nip and an outlet opening thereof, and a deflector mounted above said nip and separating said paper inlet path and said outlet path.

4. The ticket presenter as claimed in claim 3 wherein a rotation of said rollers is reversible, and further comprising a storage slot extending below said nip, for storing a portion of a ticket being printed.

5. The ticket presenter as claimed in claim 3 further comprising an outlet switch having a lever extending in said outlet path for monitoring conditions of a ticket passing through said outlet path.

6. The ticket presenter as claimed in claim 1 wherein said paper inlet switch is an optical switch with a voltage output and said optical switch has means to vary said voltage output according to a position of said lever.

7. The ticket presenter as claimed in claim 1, wherein said paper feed roller means has sufficient torque to cut a ticket from a strip of ticket paper over a tear bar.

8. The ticket presenter as claimed in claim 1, further including means to urge said lever toward said paper inlet path.

9. The ticket presenter as claimed in claim 6, wherein said means to vary said voltage output is a cam affixed to said lever and moving across a window between a light emitter and a light receiver.

10. A ticket presenter for receiving a printed ticket from a ticket printer, for pulling on said ticket in a controlled manner and for presenting said ticket to a customer; said ticket presenter comprising;
a paper inlet path therein having a downstream direction;
a paper inlet switch mounted therein having a lever extending in said paper inlet path,
a pair of driven rollers mounted therein in a downstream side of said paper inlet switch; said rollers having a nip there between;
and a feedback loop communicating to said paper inlet switch and to said driven rollers for adjusting a speed of said driven rollers according to a position of said lever in said paper inlet path.

11. The ticket presenter as claimed in claim 10, wherein said paper inlet path extends from an inlet opening thereof to said nip, and further comprising an outlet path extending from said nip to an outlet opening thereof, and a deflector mounted therein above said nip and separating said inlet path from said outlet path.

12. The ticket presenter as claimed in claim 11, wherein a rotation of said rollers is reversible, and further comprising a storage slot extending below said nip, for storing a portion of a ticket being printed.

13. The ticket presenter as claimed in claim 11, further comprising an outlet path and an outlet switch mounted therein and having a lever extending in said outlet path for monitoring conditions of a ticket passing through said outlet path.

14. The ticket presenter as claimed in claim 10 wherein said paper inlet switch is an optical switch with a voltage output, and said optical switch has means to vary said voltage output according to a position of said lever in said paper inlet path.

15. In combination, a ticket printer having an outlet side and a stationary tear bar mounted therein, and a ticket presenter affixed to said outlet side; wherein said ticket presenter comprises;
a paper inlet path communicating with said tear bar, and having a downstream direction;
a paper inlet switch having a lever extending in said paper inlet path,
a pair of driven rollers mounted in a downstream side of said paper inlet switch; said rollers having a nip there between; and a feedback loop communicating with said paper inlet switch and said driven rollers for adjusting a speed of said driven rollers according to a position of said lever in said paper inlet path, and
a strip of ticket paper extending from said ticket printer, over said tear bar, inside said paper inlet path, over said lever and into said nip.

16. The combination as claimed in claim 15, wherein said ticket presenter further comprises an outlet path extending from said nip to an outlet opening thereof, and a deflector mounted therein above said nip and separating said inlet path from said outlet path.

17. The combination as claimed in claim 16, wherein a rotation of said rollers is reversible, and said ticket presenter further comprising a storage slot extending below said nip, for storing a portion of ticket being printed.

18. The combination as claimed in claim 16, wherein said ticket presenter further comprises an outlet switch mounted therein and having a lever extending in said outlet path for monitoring conditions of a ticket passing through said outlet path.

19. The combination as claimed in claim 15 wherein said paper inlet switch is an optical switch with a voltage output, and said optical switch has means to vary said voltage output according to a position of said lever against said strip of ticket paper.

20. The combination as claimed in claim 15, further including means to urge said lever against said strip of ticket paper.
